(19) United States
(12) Patent Application Publication
(10) Pub. No.: US 2023/0026068 A1
(43) Pub. Date: Jan. 26, 2023

(54) BLAST FURNACE PLANT AND SHUTDOWN PROCESS

(71) Applicant: DANIELI CORUS B.V., Velsen Noord (NL)

(72) Inventors: Riekelt DE BOER, Velsen Noord (NL); Hendrik Adriaan Marius GEERDES, Velsen Noord (NL); Reinoud Jacobus VAN LAAR, Velsen Noord (NL); Jong Sung PARK, Dangjin City, Chungcheongnam-do (KR); Ho Young LEE, Seoul (KR)

(73) Assignee: DANIELI CORUS B.V., Velsen Noord (NL)

(21) Appl. No.: 17/757,633

(22) PCT Filed: Sep. 30, 2020
(86) PCT No.: PCT/EP2020/077330

§ 371 Date: Jun. 17, 2022

(30) Foreign Application Priority Data
Dec. 20, 2019 (EP) 19218986.8

(51) Int. Cl. C21B 7/00; C21B 7/16

(52) U.S. Cl. CPC C21B 7/002; C21B 7/16; C21B 7/007; C21B 2100/44

(57) ABSTRACT

Blast furnace plant (1) and shutdown process for such a blast furnace plant (1). The blast furnace plant comprises a blast furnace (2) and a gas cleaning section (6) for cleaning gas from the blast furnace. Clean gas is released via a clean gas vent line (11) downstream of the gas cleaning section.

The invention relates to a blast furnace plant, and to a shutdown process for interrupting operation of such a blast furnace plant.

The discussion below is merely provided for general background information and is not intended to be used as an aid in determining the scope of the claimed subject matter.

A blast furnace plant comprises a blast furnace, a hot blast generation system, an off-gas system, and a gas cleaning section for cleaning raw gas. In this context raw gas means regular process gas produced during normal operations of the blast furnace and/or any other gases which are produced during a shutdown which are usually different particularly during a blow-down. Clean gas refers to gases after passing the entire gas cleaning section. Semi-clean gas refers to gases passing only part of the gas cleaning section.

An off-gas system usually comprises one or more up-takes on top of the blast furnace and a downcomer leading from a top end of the uptake section to the gas cleaning section.

During operation of the blast furnace plant, coke and ferrous burden are charged to the blast furnace, while hot blast air, optionally with additional oxygen and/or moisture and/or fuels like pulverized coal, natural gas, hydrogen or oil is blown via the tuyeres into a lower section of the blast furnace. The end products include hot metal, slag and clean gas. The clean gas contains carbon monoxide and hydrogen and can be used as a fuel gas for heating, for example for the hot blast stoves or for the production of steam.

The raw gas flows from the blast furnace to the gas cleaning section. The gas cleaning section typically comprises dust removal equipment. Examples of such gas removal equipment include gravity or cyclone dust catchers, mostly followed by a wet scrubber. If a wet scrubber is used, a demister can be placed downstream of the gas cleaning section for separating the scrubbing liquid from the gas flow. Instead of a wet scrubber with a demister, dry systems such as filter bag stations and/or electrostatic precipitators can be used. The clean gas is typically transported to a gas grid.

Blast furnaces are typically provided with one or more bleeder valves, usually at the top ends of the uptakes, for relieving pressure peaks and temperature peaks and preventing emergency situations. The bleeder valves are also used to reduce pressure to atmospheric level and to vent residual raw gas during a shutdown.

Blast furnaces are typically further provided with multiple purging gas supplies for example using nitrogen and/or steam and/or other purging gases. These purging gas flows can be transported to either the gas grid and/or to ambient air depending on the circumstances.

Besides the frequent regular shutdowns the blast furnace can also be shut down by means of a so-called blow down, for example for more intensive repair and/or maintenance of the blast furnace. Blowing down a blast furnace plant requires operating the blast furnace without charging the blast furnace. The charge level in the blast furnace gradually decreases. When the predefined conditions in the blast furnace are reached, the bleeder valves are opened. The interior of the blast furnace and/or gas cleaning section is mostly purged with steam and/or nitrogen, to prevent explosive concentrations of gas mixtures.

Raw gas released via the one or more bleeder valves does not only have a high content of hazardous gas components but also causes substantial emission of dust.

In some blast furnace plants, one or more additional bleeder valves are used, e.g., between subsequent stages of the gas cleaning section and/or at a top end of the downstream scrubber. Such so-called semi-clean gas bleeder valves release semi-clean gas with a lower dust content, but the released gas still is polluting.

The object of the invention is to provide a shutdown process with substantially less dust emission and less impact on the environment.

This disclosure is provided to introduce a selection of concepts in a simplified form. This disclosure is not intended to identify key features or essential features of the claimed subject matter, nor are they intended to be used as an aid in determining the scope of the claimed subject matter.

The object of the invention is achieved with a process of shutting down a blast furnace plant comprising a blast furnace, a hot blast generating system, and a gas cleaning section for cleaning gas from the blast furnace, wherein clean gas is released with a substantially lower dust content via a clean gas vent line downstream of the gas cleaning section.

In a specific embodiment the process includes the step of reducing hot blast pressure and flow to a set value, and subsequently generating a flow from the tuyeres of the blast furnace to the clean gas vent line. The flow can be generated by gas forming chemical reactions in the blast furnace. Optionally, a supporting flow can be generated by flow generating means upstream or downstream of the blast furnace. The supporting flow can be generated by injecting a gas, preferably an inert gas, such as nitrogen, into the blast furnace. Alternatively, or additionally, the flow can be generated by suction in the clean gas vent line, e.g., by a pressure reducer, such as an ejector or one or more gas pumps or fans.

The flow can be maintained for a set period until the furnace burden practically stops producing carbon monoxide and dust. This typically occurs when practically all FeO in the burden is reduced to iron and carbon monoxide. Subsequently, the bleeder valve or valves can be opened and the clean gas vent line can be closed.

The process can be carried out using a flare usually present in the gas grid. However, it is preferred that the process is carried out with a blast furnace plant comprising a clean gas vent line downstream of the gas cleaning section, in particular a clean gas vent line with a capacity to vent clean gas to the environment during a shutdown procedure, in particular when the clean gas transport line to the gas grid is closed. For most cases, a capacity of at least, e.g., about 900 Nm³/min, e.g., at least about 1000 Nm³/min would be sufficient. This flow depends on the size of the blast furnace and specific process conditions.

If a wet scrubber is used, the blast furnace plant will typically comprise a demister downstream of the gas cleaning section. In such a case, the clean gas vent line can be downstream or upstream of the demister.

In a specific embodiment, the blast furnace plant comprises means for generating a flow between the tuyeres and the clean gas vent line. These means for generating a flow may for instance include a source for a gas, preferably an inert gas, such as nitrogen, operatively connected to the tuyeres. Alternatively, or additionally, the means for generating a flow include one or more pressure reduction devices downstream the gas cleaning section, such as an ejector, or a gas pump, such as a fan.

In a specific embodiment, the clean gas vent line may extend above the level of the clean gas transport line to the gas grid, for example up to the top level of the blast furnace, or higher.

The blast furnace plant may further comprise a set of valves for selectively closing off the clean gas vent line and the clean gas transport line to the gas grid. During shutdown, the clean gas vent line is opened and subsequently the clean gas transport line to the gas grid is closed. During normal operation of the blast furnace plant, the clean gas vent line is closed, while the clean gas transport line to the gas grid is open.

The above-described aspects will hereafter be more explained with further details and benefits with reference to the drawings showing a number of embodiments by way of example.

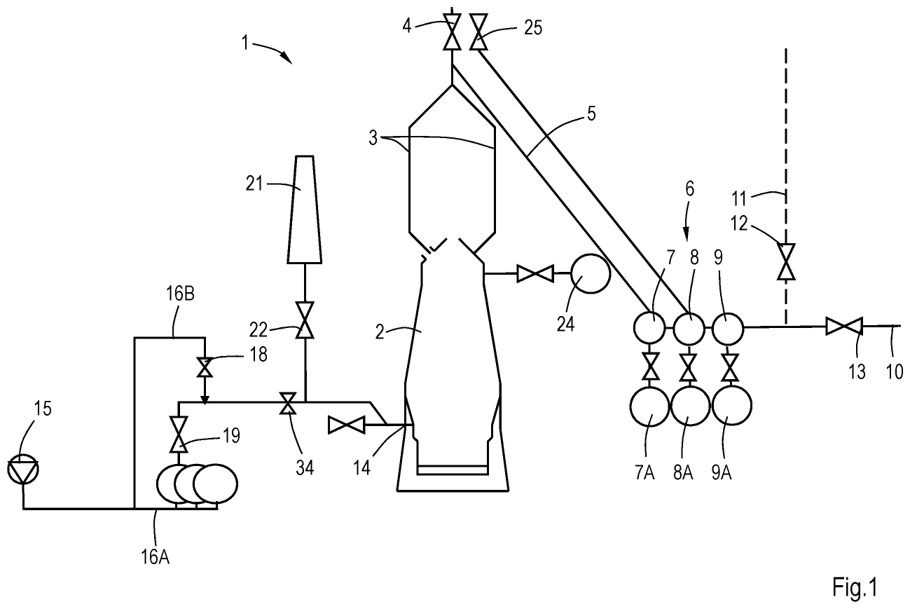

FIG. 1: shows a first embodiment of a blast furnace plant according to the invention;

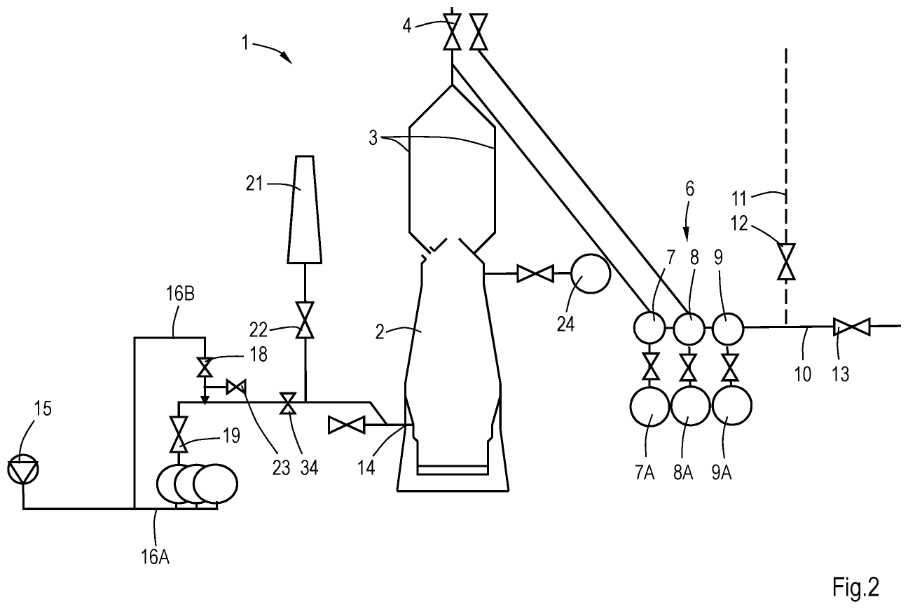

FIG. 2: shows a second embodiment of a blast furnace plant according to the invention;

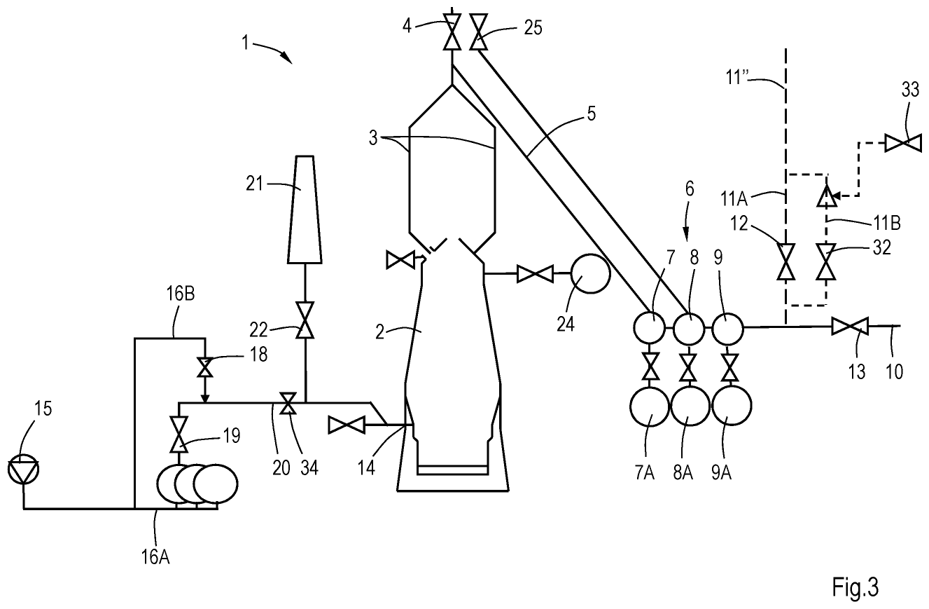

FIG. 3: shows a third embodiment of a blast furnace plant according to the invention.

FIG. 1 shows schematically an exemplary embodiment of a blast furnace plant 1 of the present invention. The blast furnace plant 1 comprises a blast furnace 2 and an off-gas system, in this particular embodiment embodied as an uptake 3 on top of the blast furnace 2. The shown embodiment has multiple uptakes 3, schematically represented in the drawing by a single line, but blast furnaces without an uptake or having only one uptake can also be used. Present-day blast furnaces mostly comprise a configuration of multiple uptakes joining each other at their top ends.

On top of the uptake 3 is a bleeder valve 4. Most blast furnaces have multiple bleeder valves on a bleeder platform above the junction of multiple uptakes.

A downcomer 5 transports raw gas from the top of the uptake 3 down to a gas cleaning section 6. The gas cleaning section 6 can have any suitable arrangement of dust removal systems, but typically comprises a gravity or cyclone dust catcher 7, usually followed by a wet scrubber 8 or a filter bag station or an electrostatic precipitator. If a wet scrubber is used, the blast furnace plant will usually also be provided with a demister 9 downstream of the gas cleaning section for separating the scrubber liquid. All gas cleaning equipment 7, 8 and the demister 9 can have associated purging gas supplies, for example at positions 7A, 8A, 9A.

A clean gas transport line 10 transports clean gas from the gas cleaning section, for example to the gas grid. A clean gas vent line 11 branches off from the clean gas transport line 10. The clean gas vent line 11 is closable by a vent valve 12. A clean gas isolation valve 13 is located downstream of the clean gas vent line 11.

At the inlet side the blast furnace 2 comprises tuyeres 14 forming a hot blast inlet to the blast furnace. The tuyeres 14 are evenly distributed around the circumference of the blast furnace, usually via a bustle main.

A blower 15 blows compressed air via a supply line 16 which, at a distance downstream of the blower 15, is split into a first branch 16A with hot blast stoves 17 for heating the air, and a second branch 16B without such stoves. Each one of the stoves 17 comprises its own valve 19. The two branches 16A, 16B join each other at a downstream point to form a blast mixing circuit. The valves 18, 19 can be used to meter and mix the flows of the two branches 16A, 16B to produce a blast of a desired temperature entering the blast furnace 2 at a given hot blast pressure. Additional oxygen and/or moisture and/or fuels like pulverized coal, natural gas, hydrogen or oil and/or other components can be added to the hot blast air, if so desired.

The supplied air flows via a line 20 to the tuyeres 14 of the blast furnace 2. In the shown exemplary embodiment, this line 20 can be provided with a backdraft stack 21 closable by a valve 22. Opening the valve 22 facilitates venting of gaseous products from the blast furnace 2 after a shutdown. Alternatively, the blast furnace plant 1 can be without such a back draft stack 21.

Some blast furnace plants may have a hot blast main isolation valve 34 just upstream of the bustle main of the tuyeres 14 or, if a back draft stack 21 is present, just upstream of the back draft stack 21.

The blast furnace 2 is provided with purging gas supplies 24. Typical purging gases are nitrogen and/or steam.

On top of the wet scrubber 8 is a line to a semi-clean gas bleeder valve 25.

During normal operation of the blast furnace plant 1, ferrous burden and coke are charged in discrete layers up to the top section of the blast furnace 2. Hot blast air of about 1200° C. is supplied to the blast furnace 2 via the tuyeres 14, optionally with additional oxygen and/or moisture and/or fuels like pulverized charcoal, natural gas, hydrogen or oil. The hot blast gasifies the coke and injected fuels, heating, reducing and melting the ferrous burden to form liquid hot metal, slag and raw gas. During normal operation the pressure in the blast furnace is typically about 2-5 bar. The raw gas is collected in the uptake section 3 and transported via the downcomer 5 to the gas cleaning section 6, where most of the dust content is removed and the pressure is reduced to the pressure of the gas grid, typically about 40-100 mbar. After passing the gas cleaning section 6 the clean gas is transported via the clean gas transport line 10 to the gas grid. The collected clean gas can be used as a fuel for heating, for example for the hot blast stoves or the production of steam.

Occasionally, it is required to shut down the blast furnace plant 1 by means of a blow down. In a first step of such a blow down procedure the blast furnace is operated without further charging the blast furnace. The charge level in the blast furnace 2 gradually decreases. In this stage, the clean gas vent line 11 is closed and the clean gas is transported via the clean gas transport line 10 to the gas grid.

When the carbon monoxide level is below a threshold value, for example below 7 vol. % by dry volume of the raw gas, the clean gas vent line is opened and subsequently the clean gas isolation valve 13 of the clean gas transport line 10 to the gas grid is closed off, so the clean gas flows via the clean gas vent line 11. When the oxygen content of the raw gas in the blast furnace 2 exceeds a threshold value, for example about 2 vol % of the total volume of the raw gas within the blast furnace, and the burden is at about the level of the tuyeres 14, the pressure of the hot blast at the tuyeres 14 is reduced to a lower value, e.g. about 0.1 bar. The valve 18 of the cold blast line 16B is then opened while the hot blast valve 19 is closed off. The valve 18 of the cold blast line 16B is controlled to maintain a pressure difference of about 10-30 mbar between the pressure in the blast furnace 2 and the pressure in the clean gas vent line 11. Subsequentially the bleeder valves 4 are opened and the vent line 11 is closed off.

FIG. 2 shows an alternative embodiment of a blast furnace plant 1′. All components of the plant are the same as in FIG. 1, except that a nitrogen supply line 23 is connected downstream of the valve 18 for closing off the second branch 16B of the blast mixing circuit, and upstream of the optional valve 34. Alternatively, the nitrogen supply 23 can be connected at any position on the supply line 20 upstream from the tuyeres 14.

When the blast furnace plant 1′ of FIG. 2 is shut down, the hot blast pressure in the blast furnace 2 is first reduced to about 0.2-0.3 bar by reducing the hot blast inlet flow via the tuyeres 14. In a next step, the purging gas supplies 24 for the blast furnace 2 are opened. Then the clean gas vent line valve 12 of the clean gas vent line 11 is opened and the valve 13 of the clean gas transport line to the gas grid is closed. Mostly, the hot blast pressure is then further reduced to about 0.1 bar. Optionally, the vented clean gas can be flared.

In a next step, the nitrogen supply 23 is opened and the valves 18 and 19 of the blast air branches 16A, 16B are closed. The nitrogen supply creates a flow between the blast furnace 2 and the clean gas vent line 11 maintaining the upward flow through the blast furnace 2. Since the supply of oxygen containing hot blast air is stopped, the production of carbon monoxide and dust will gradually be reduced, although for a while iron oxide (FeO) will react with the coke to produce carbon monoxide and dust. In this stage the raw gas has a low dust content and the clean gas vent line 11 can be closed after the bleeder valves 4 on top of the uptakes 3 are opened.

Subsequently, existing procedures for finalization of the shutdown can be followed accounting for the fact that residual nitrogen could be present in the hot blast main.

FIG. 3 shows an alternative embodiment of a blast furnace plant 1″ according to the invention. In this embodiment, there is no nitrogen supply line 23 in the configuration of the hot blast supply circuit 16A, 16B. Instead, the clean gas vent line 11″ is provided with an ejector 30 for increasing the pressure drop and promote the flow by suction. The clean gas vent line 11″ splits into a first branch 11A without the ejector 30 and a second branch 11B with the ejector 30. Downstream of the ejector 30 the two lines 11A, 11B join again as a single exhaust. Valves 12, 32 are used to close off one of the lines after opening the other line, so the clean gas vent line 11″ can selectively be used with or without the ejector 30. The ejector 30 is connected to a supply 33 of an inert motive gas, such as steam or nitrogen.

When the blast furnace plant 1″ is shut down, the hot blast pressure is first reduced to 0.2-0.3 bar by reducing the hot blast inlet flow. In a next step, the purging gas supplies 24 for the blast furnace 2 are opened. Then the valve 12 of the clean gas vent line 11A bypassing the ejector 30 is opened and the clean gas isolation valve 13 of the clean gas transport line 10 to the gas grid is closed. The hot blast pressure is then further reduced to about 0.1 bar.

In a next step the ejector 30 is opened while the line 11A bypassing the ejector 30 is closed. The pressure in the system is controlled by the suction generated by the ejector 30. After a set period the bleeder valves 4 on top of the uptakes 3 are opened and subsequently the ejector 30 and the clean gas vent line 11′ are closed off.

Further embodiments can for example comprise both the ejector 30 as well as the nitrogen supply 23 and/or comprise further means to promote the gas flow from the blast furnace to the clean gas vent line.

1. A process of shutting down a blast furnace plant comprising a blast furnace and a gas cleaning section for cleaning gas from the blast furnace, said method comprising:
releasing clean gas via a clean gas vent line downstream of the gas cleaning section;
reducing hot blast pressure and/or flow to a set value; and
subsequently generating a flow from tuyeres of the blast furnace to the clean gas vent line.

2. The process of claim 1, wherein the flow is generated by injecting a gas into the blast furnace.

3. The process of claim 1, wherein the flow is generated by suction in the clean gas vent line.

4. The process of claim 1, wherein the flow is maintained for a set period and further comprising a step of subsequently opening at least one bleeder valve of the blast furnace and closing the clean gas vent line.

5. A blast furnace plant comprising a blast furnace, a gas cleaning section, and a clean gas transport line to a gas grid for further transport of cleaned gas, wherein the clean gas transport line to the gas grid is provided with a clean gas vent line, and the blast furnace comprises tuyeres and means for generating a flow from the tuyeres of the blast furnace to the clean gas vent line.

6. The blast furnace plant of claim 5, wherein the means for generating a flow includes a source for a gas.

7. The blast furnace plant of claim 5, wherein the means for generating a flow includes a pressure reduction device downstream of the gas cleaning section.

8. The blast furnace plant of claim 7, wherein the pressure reduction device comprises an ejector and/or one or more pumps and/or one or more fans.

9. The blast furnace plant of claim 5, wherein the clean gas vent line extends above a level of the clean gas transport line to the gas grid.

10. The blast furnace plant of claim 5, wherein the clean gas vent line is connected to a flare.

11. The blast furnace plant of claim 5, wherein the clean gas vent line is connected to one or more further vent lines.

12. The process of claim 3, wherein the flow is generated by a pressure reducer.

13. The process of claim 12, wherein the pressure reducer is selected from the group consisting of an ejector, one or more gas pumps and one or more fans.

14. The process of claim 1, wherein the flow is generated by injecting a gas into the blast furnace or by suction in the clean gas vent line and wherein the flow is maintained for a set period and further comprising a step of subsequently opening at least one bleeder valve of the blast furnace and closing the clean gas vent line.

15. The blast furnace plant of claim 9, wherein the level of the clean gas transport line is up to a top level of the blast furnace or higher.

16. The blast furnace plant of claim 11, wherein the one or more further vent lines are selected from the group consisting of a semi-clean gas vent line and a chimney.

17. The blast furnace plant of claim 5, wherein the means for generating a flow includes a source for a gas and a pressure reduction device downstream of the gas cleaning section.

18. The blast furnace plant of claim 17, wherein the pressure reduction device comprises an ejector and/or one or more pumps and/or one or more fans.

19. The blast furnace plant of claim 18, wherein the clean gas vent line extends above a level of the clean gas transport line to the gas grid.

20. The blast furnace plant of claim 19, wherein the clean gas vent line is connected to one or more further vent lines.
